(19) United States
(12) Patent Application Publication
(10) Pub. No.: US 2024/0106138 A1
(43) Pub. Date: Mar. 28, 2024

(54) ELECTRIC CONNECTING APPARATUS

(71) Applicant: Robert Bosch GmbH, Stuttgart (DE)

(72) Inventor: Jivan Kapoor, Stuttgart (DE)

(21) Appl. No.: 18/264,962

(22) PCT Filed: Dec. 23, 2021
(86) PCT No.: PCT/EP2021/087588

§ 371 Date: Aug. 10, 2023

(30) Foreign Application Priority Data
Feb. 16, 2021 (DE) 10 2021 201 454.2

(51) Int. Cl. H01R 12/53; H01R 4/02; H01R 43/02

(52) U.S. Cl. CPC H01R 12/53; H01R 4/023; H01R 43/0228

(57) ABSTRACT

For an electrical connecting apparatus (1), in particular for connecting an electrical and/or electronic component (2) to a conductor substrate (3), comprising an electrically conductive contact-making element (10) and an electrical conductor (20), wherein one end (21) of the electrical conductor (20) is electrically conductively connected to the contact-making element (10), the invention proposes that the contact-making element (10) is of fork-like design with at least one first tine (11) and at least one second tine (12), wherein the first tine (11) is spaced apart from the second tine (12) by an intermediate space (13), wherein the end (21) of the electrical conductor (20) is arranged in the intermediate space (13) between the first tine (11) and the second tine (12) and is electrically conductively connected to the first tine (11) and/or the second tine (12).

### BACKGROUND

The invention relates to a connecting apparatus, in particular for connecting an electrical and/or electronic component to a conductor substrate, and to an assembly comprising such a connecting apparatus.

Electrical and/or electronic components often comprise conductors designed as high-frequency strands. These conductors designed as strands comprise a plurality of insulated individual conductors that are combined into a bundle. The high-frequency strands reduce losses in the components due to heating by skin and proximity effects. Usually, conductors configured as a strand are electrically contacted to a THT or SMD pin to be able to connect the electrical and/or electronic component to a conductor substrate, for example a printed circuit board. The attachment of the strand to the THT or SMD pin is difficult if the number of individual conductors that make up the strand becomes very large and they have a small diameter. A high number of individual conductors makes it difficult to handle and apply solder to the connection point, or to penetrate and contact the stranded bundle with solder. Furthermore, for example, individual small-diameter conductors made of copper can dissolve in the solder or in the solder of solder baths if long soldering times are required or must be sought to achieve the desired contact.

### SUMMARY

According to the invention, a connecting apparatus, in particular for connecting an electrical and/or electronic component to a conductor substrate, is proposed. The connecting apparatus comprises an electrically conductive contact-making element and an electrical conductor, one end of the electrical conductor being electrically conductively connected to the contact-making element. According to the invention, the contact-making element is of fork-like design with at least one first tine and at least one second tine, the first tine being spaced apart from the second tine by an intermediate space, the end of the electrical conductor being arranged in the intermediate space between the first tine and the second tine and being electrically conductively connected to the first tine and/or the second tine.

Compared to the prior art, the connecting apparatus having the features of the disclosure has the advantage that an electrical connection, which is simple to produce and is stable at the same time, can be produced between the conductor and the contact-making element. Thus, a conductor of an electrical and/or electronic component can advantageously be brought into good and easy contact with the contact-making element. The contact-making element can then be soldered, for example using a foot formed on the contact-making element, to a conductor substrate, for example a printed circuit board. The intermediate space between the tines of the fork-like contact-making element provides an advantageously good receptacle for the end of the conductor in which the end of the conductor is held and can then advantageously be well and easily soldered or welded to the contact-making element. Instead of winding the end of the conductor for contacting the contact-making element, for example, around the contact-making element, the latter can be easily accommodated in the intermediate space between the tines of the contact-making element.

According to an advantageous embodiment, the electrical conductor is configured as a strand that comprises a plurality of individual conductors, in particular individual wires. A conductor configured in this way is advantageously flexible and can advantageously be fitted easily in the intermediate space between the tines of the fork-like contact-making element. The end of a conductor configured as a strand can advantageously be well deformed, in particular pressed flat. Advantageously, it can be easily inserted into the, for example, elongated intermediate space between the tines and be connected therein to the contact-making element, for example by soldering or welding. In this case, the end of the conductor can advantageously be held well between the tines of the contact-making element during the soldering or welding process.

According to an advantageous embodiment, the electrical conductor configured as a strand is fanned out at the end such that the individual conductors are arranged at least partially one above the other in the intermediate space between the tines. The electrical conductor is thus flat at the end. The individual conductors are not arranged at the end in a bundle having a substantially circular cross section, as in other regions of the conductor, but are fanned out. The individual conductors are thus arranged at least partially one above the other in the intermediate space. At the end, the conductor has a flattened cross section in comparison to the otherwise circular cross section. Thus, an advantageously large number of individual conductors can be placed on the tines of the contact-making element at the end of the conductor and can be electrically conductively connected, in particular soldered or welded, thereto. The contact surface between the end of the conductor and the contact-making element is advantageously enlarged in this way and thus advantageously good electrical contact between the conductor and the contact-making element is produced. Due to the fanned-out end and the open, penetrable strand cross section located directly on the contact-making element to be connected, the individual conductors are more accessible to the solder for connecting the conductor to the contact-making element, and a better connection of the conductor to the contact-making element can thus be achieved.

According to an advantageous embodiment, a structure is formed on a side of the first tine facing the second tine and/or on a side of the second tine facing the first tine. The structure is in electrical contact with the end of the electrical conductor. The contact between the conductor and the contact-making element is advantageously improved by the structure. The structure can advantageously hold the end of the conductor in the intermediate space between the tine and advantageously increase the contact surfaces between the end of the conductor, the contact-making element and also, for example, the glued solder, such that a particularly good and stable electrical connection is established between the conductor and the contact-making element.

According to an advantageous embodiment, the structure is barb-like with teeth, the teeth projecting from each tine toward the intermediate space between the tines and being in electrical contact with the end of the conductor arranged in the intermediate space. The end of the conductor is thus held in the intermediate space by the teeth on the first tine and/or on the second tine of the contact-making element. In particular, individual conductors or bundles of individual conductors can also be held on a tine at the end of the conductor between the teeth, in particular also between successive teeth.

According to an advantageous embodiment, the tines are spaced apart from one another by a distance, the distance being smaller than a diameter of the electrical conductor in the region before the end of the electrical conductor. Thus, the end of the conductor is also pressed flat and the conductor no longer has a circular cross section at the end. The end of the conductor is arranged completely in the intermediate space between the tines of the fork-like contact-making element. When the conductor is introduced into the intermediate space between the tines, which is narrow in comparison to the otherwise circular cross section of the conductor, the end of the conductor can be pressed flat, such that the individual conductors are arranged one above the other in the intermediate space and the end of the conductor assumes a flattened cross section in comparison to the rest of the conductor. Thus, the individual conductors are made accessible over a larger area, for example to the soldering process or the welding process, and an advantageously good connection can be produced between the contact-making element and the conductor.

According to an advantageous embodiment, a foot for attaching the electrically conductive contact-making element to the conductor substrate is formed on the electrically conductive contact-making element. The foot can, for example, be soldered to the conductor substrate, for example in an SMD process. The connecting apparatus can thus be used to connect an electrical and/or electronic component having a conductor connected to the contact-making element to the conductor substrate by means of an SMD process. Thus, the contact-making element is designed, for example, as an SMD pin, which is of fork-like design with the two tines at one end of the pin and has the foot at the other end.

According to an advantageous embodiment, the end of the electrical conductor is soldered or welded to the electrically conductive contact-making element, in particular is soldered or welded to at least one of the tines of the electrically conductive connecting element. A particularly good and stable connection is thus produced between the conductor and the contact-making element. Laser welding or laser soldering, for example, can be used for connecting. In the case of soldering or welding, the fanning out of the strand can also be advantageously based on insulating layers, for example of lacquer, around the individual conductors.

According to an advantageous embodiment, the tines of the electrically conductive connecting element are pressed together such that the end of the electrical conductor is clamped between the tines. The tines of the electrically conductive connecting element are thus pressed against each other during the manufacture of the connecting apparatus, wherein the end of the conductor is additionally fastened. Furthermore, the end of the conductor can be advantageously compressed when the tines are pressed together such that the individual conductors of the conductor fan out further in the intermediate space along the longitudinal extension of the tines, thus providing an advantageously large contact surface between the tines and the conductor and supporting solder penetration.

Furthermore, according to the invention, an assembly comprising an electrical connection device is provided, wherein the assembly further comprises at least one electrical and/or electronic component and at least one conductor substrate, wherein the conductor is designed for electrically contacting the electrical and/or electronic component and the contact-making element is electrically conductively connected, in particular soldered, to the conductor substrate.

### BRIEF DESCRIPTION OF THE DRAWING

One embodiment of the invention is illustrated in the drawings and explained in more detail in the following description. In the drawings:

FIG. 1 is a schematic view of a first embodiment of an assembly comprising an electrical and/or electronic component and a conductor substrate that are connected by means of an electrical connection device.

### DETAILED DESCRIPTION

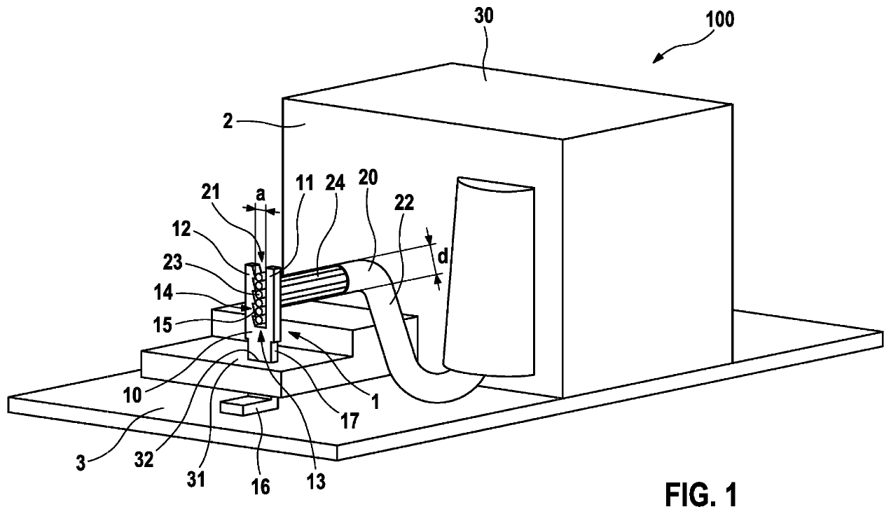

FIG. 1 shows an assembly 100 that comprises an electrical and/or electronic component 2 and a conductor substrate 3. The electrical and/or electronic component 2 is electrically conductively connected to the conductor substrate 3 by means of a connecting apparatus 1. The conductor substrate 3 can be, for example, a printed circuit board or a power substrate, for example a DBC substrate. The electrical and/or electronic component 2 can be, for example, an inductive component, for example a choke or a transformer. The electrical and/or electronic component 2 can be arranged, for example, in a housing 30, for example made of plastic.

An electrical conductor 20 is provided for connecting the electrical and/or electronic component 2. The electrical and/or electronic component 2 can be electrically contacted by means of the electrical conductor 20. Thus, the electrical and/or electronic component 2 can be electrically connected to further conductors, for example conductor tracks of a conductor substrate 3 or to further electrical and/or electronic components. If the electrical and/or electronic component 2 is designed, for example, as an inductive component, the conductor 20 can, for example, be wound around a magnetically active core (not shown) and thus form a choke or a transformer, for example. In addition to the conductor 20 shown, further conductors can also be provided on which the electrical and/or electronic component 2 can be electrically contacted. In the embodiment shown, the conductor 20 is designed as a strand 22, in particular as a high-frequency strand. The strand 22 comprises a plurality of individual conductors 23. The individual conductors 23 are combined in the strand 22 as bundles. A strand 22 can comprise, for example, more than 100 individual conductors 23. Each individual conductor 23 is electrically insulated from the other individual conductors 23 by an insulation layer. The individual conductors 23 can be designed, for example, as individual wires. The individual conductors 23 can each have a diameter of less than 500 micrometers, in particular less than 200 micrometers, preferably, for example, 50 micrometers. The individual conductors 23 of a strand 22 are, for example, all of the same design. The individual conductors 23 can each have an insulation, for example made of lacquer, which electrically separates them from the other individual conductors 23. Furthermore, the strand 22 can comprise one or more outer sheaths that surround and enclose the bundle of individual conductors 23. The individual conductors 23 can be braided together in the bundle of individual conductors 23.

As shown in the FIGURE, the conductor 20 consists of a region 24 in which the individual conductors 23 of the conductor 20 are bundled. In this region 24, the conductor 20 has, for example, a substantially circular cross-sectional area. An end 21 of the electrical conductor 20 adjoins the region 24. At the end 21 of the conductor 20, the conductor 20 does not have a circular cross section, but rather a cross section pressed flat in comparison to the region 24 having the substantially circular cross section. The bundle of individual conductors 23 is pressed flat at the end 21 of the conductor 20 designed as a strand 22. The individual conductors 23 are fanned out at the end 21 of the conductor 20. To this end, the outer sheath of the strand 22, which forms a common sheath around all the individual conductors 23, is removed at the end 21 of the conductor 20.

As shown in the FIGURES, the connecting apparatus 1 further comprises a contact-making element 10. The contact-making element 10 can be designed, for example, as a pin, for example as an SMD pin or THT pin, and can be provided for connection to a conductor substrate 3, in particular a printed circuit board. In the embodiment shown in the FIGURE, the contact-making element 10 is designed as an SMD pin. A foot 16 with which the contact-making element 10 is connected to the conductor substrate 3 is formed on the contact-making element 10. As shown in the FIGURE, the contact-making element 10 is formed in a fork-like manner on the side facing away from the conductor substrate 3. Two tines 11, 12, a first tine 11 and a second tine 12 are formed on the contact-making element 10 for this purpose. The first tine 11 and the second tine 12 are arranged parallel to one another or with a slight opening angle (funnel effect upon insertion of the strand). The first tine 11 and the second tine 12 have the same or similar length. The first tine 11 and the second tine 12 adjoin a base region 17 of the contact-making element 10. The base region 17 of the contact-making element 10 extends in an elongate manner, for example in a direction perpendicular to the conductor substrate 3 away from the conductor substrate 3. In this exemplary embodiment, the foot 16 of the contact-making element 10 is formed on an end of the base region 17 of the contact-making element 10 facing the conductor substrate 3. The tines 11, 12 of the contact-making element 10 are formed on an end of the base region 17 of the contact-making element 10 facing away from the conductor substrate 3. A structure in the form of teeth 15 is formed on each of the tines 11, 12. The teeth 15 protrude from mutually facing inner sides of the prongs 11, 12. The teeth 15 serve to fix the bundle of individual conductors 23 to the end 21 of the conductor 20.

The contact-making element 10 is fixed to the electrical and/or electronic component 2. For this purpose, a holding part 31 is formed on the housing 40 of the electrical and/or electronic component 2. In the holding part 31 for the contact-making element 10, for example, a recess 32 can be formed through which the contact-making element 10 is guided and through which the contact-making element 10 is held on the holding part 31 and thus on the housing 30 of the electrical and/or electronic component 2.

The end 21 of the conductor 20 is arranged in the intermediate space 13 between the first tine 11 and the second tine 12. The intermediate space 13 is narrow such that the end 21 of the conductor 20 is compressed and thus flattened. The first tine 11 is spaced apart from the second tine 12 by a distance a. The distance a is measured perpendicular to the tines 11, 12. The distance a is less than a diameter d of the conductor 20 in the region 24 of the conductor 20 in which the individual conductors 23 of the conductor 20 form a bundle having a substantially circular cross section. The end 21 of the conductor 20 is electrically conductively and mechanically connected to the first tine 11 and or to the second tine 12 of the contact-making element 10. For this purpose, in this embodiment, the individual conductors 23 are soldered or welded to the first tine 11 and/or the second tine 12, for example by means of a laser. If the end 21 of the conductor 20 is welded to the contact-making element 10, at least one element for holding the end 21 of the conductor 20 can additionally be provided in the holding part.

Of course, further embodiments and combined forms of the embodiments shown are also possible.

1. An electrical connecting apparatus (1) for connecting an electrical and/or electronic component (2) to a conductor substrate (3), the electrical connecting apparatus (1) comprising an electrically conductive contact-making element (10) and an electrical conductor (20), one end (21) of the electrical conductor (20) being electrically conductively connected to the contact-making element (10),
wherein the contact-making element (10) is of fork-like design with at least one first tine (11) and at least one second tine (12), the first tine (11) being spaced apart from the second tine (12) by an intermediate space (13), the end (21) of the electrical conductor (20) being arranged in the intermediate space (13) between the first tine (11) and the second tine (12) and being electrically conductively connected to the first tine (11) and/or the second tine (12).

2. The electrical connecting apparatus (1) according to claim 1, wherein the electrical conductor (20) is configured as a strand (22) that comprises a plurality of individual conductors (23).

3. The electrical connecting apparatus (1) according to claim 2, wherein the electrical conductor (20) configured as a strand (22) is fanned out at the end (21) such that the individual conductors (23) are arranged at least partially one above the other in the intermediate space (13) between the tines (11, 12).

4. The electrical connecting apparatus (1) according to claim 1, wherein a structure (14) is formed on a side of the first tine (11) facing the second tine (12) and/or on a side of the second tine (12) facing the first tine (11), the structure (14) being in electrical contact with the end (21) of the electrical conductor (20).

5. The electrical connecting apparatus (1) according to claim 1, wherein the structure (14) is barb-like with teeth (15), the teeth (15) projecting from each tine (11, 12) toward the intermediate space (13) between the tines (11, 12) and being in electrical contact with the end (21) of the conductor (20) arranged in the intermediate space (13).

6. The electrical connecting apparatus (1) according to claim 1, wherein the tines (11, 12) are spaced apart from one another by a distance (a), the distance (a) being smaller than a diameter (d) of the electrical conductor (20) in the region (24) before the end (21) of the electrical conductor (20).

7. The electrical connecting apparatus (1) according to claim 1, wherein a foot (16) for attaching the electrically conductive contact-making element (10) to the conductor substrate (3) is formed on the electrically conductive contact-making element (10).

8. The electric connecting apparatus (1) according to claim 1, wherein the end (21) of the electrical conductor (20) is soldered or welded to the electrically conductive contact-making element (10).

9. The electrical connecting apparatus (1) according to claim 1, wherein the tines (11, 12) of the electrically conductive connecting element (10) are pressed together such that the end (21) of the electrical conductor (20) is clamped between the tines (11, 12).

10. An assembly comprising an electrical connecting apparatus (1) according to claim 1, wherein the assembly (100) further comprises at least one electrical and/or electronic component (2) and at least one conductor substrate (3), wherein the conductor (20) is designed for electrically contacting the electrical and/or electronic component (2) and the contact-making element (10) is electrically conductively connected to the conductor substrate (3).
